(19) United States
(12) Patent Application Publication
(10) Pub. No.: US 2008/0150321 A1
(43) Pub. Date: Jun. 26, 2008

(54) VEHICLE HAVING AERODYNAMIC FAN ELEMENTS

(76) Inventor: Colin Neale, Northville, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/933,840

(22) Filed: Nov. 1, 2007

Related U.S. Application Data
(60) Provisional application No. 60/863,878, filed on Nov. 1, 2006.

(51) Int. Cl. B62D 35/00

(52) U.S. Cl. 296/180.1

(57) ABSTRACT

A vehicle is provided with a front end, a rear end, and at least one fan element for controlling a flow of air toward and from the rear end of the vehicle, so as to minimize turbulence and any resulting aerodynamic drag behind the vehicle. The fan element may be coupled to a weighted flywheel for storing kinetic energy and driving the fan element during low vehicle speeds or stops.

### REFERENCE TO RELATED APPLICATIONS

This application claims priority to U.S. provisional patent application No. 60/863,878, which was filed Nov. 1, 2006 and is incorporated herein by reference in its entirety.

### FIELD OF THE INVENTION

The invention relates to aerodynamic control elements for automotive vehicles. More particularly, the invention relates to a vehicle having fan elements for controlling aerodynamic flow and minimizing drag.

### BACKGROUND OF THE INVENTION

The movement of a motor vehicle involves providing enough power to overcome, at least in part, aerodynamic drag. The efficiency of the shape of a vehicle in minimizing aerodynamic drag is referred to as drag coefficient. In general, drag can be minimized by promoting and maintaining laminar flow over the surface of the vehicle body. It is widely recognized that a ‘perfect’ vehicle body shape in terms of drag efficiency is a teardrop shape. Such a shape, however, poses other issues related to vehicle packaging, practicality and marketability. Modern production car designs have progressed significantly from early, chunky vehicle designs by making substantial improvements to the aerodynamic efficiency of the front two-thirds of the vehicle, i.e. to about the maximum cross sectional point of the vehicle. The demand, however, for a usable trunk space and rear indicator lighting in a typical vehicle dictate a generally truncated rear end, which results in turbulence. Turbulence behind the rear end of a moving vehicle is a major source of drag.

Typically, fixed wing elements or “spoilers” are used in an attempt to control the turbulence and also provide down force to improve rear wheel traction. The effectiveness of fixed spoilers is limited, however, at normal city or highway speeds. Accordingly, it remains desirable to provide an aerodynamic control element that improves over conventional designs by specifically addressing the need to minimize drag due to turbulence behind the rear end of the vehicle.

### SUMMARY OF THE INVENTION

According to one aspect of the invention, a vehicle is provided with a front end, a rear end, and at least one fan element for controlling a flow of air toward and from the rear end of the vehicle, so as to minimize turbulence and any resulting aerodynamic drag behind the vehicle.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a rear perspective view of a vehicle having fan elements according to one embodiment of the invention;

FIG. 2 is a front perspective view of another vehicle having fan elements similar to those in FIG. 1;

FIG. 3 is a side perspective view of a vehicle according to a second embodiment, in which the fan elements are packaged integrally in the rear quarter panel;

FIG. 4 is a rear perspective view of a vehicle according to a third embodiment, in which the fan elements are packaged integrally with the rear quarter panel and disposed below a fixed wing spoiler;

FIG. 5 is a side elevational view of a vehicle according to a fourth embodiment, in which the fan elements are coupled to flywheels and are disposed behind a side-mounted scoop;

FIG. 6 is a rear perspective view of a vehicle according to a fifth embodiment;

FIG. 6a is a top-elevational view of the vehicle of FIG. 6; and

FIG. 7 is a side elevational view of a vehicle according to a sixth embodiment, in which a vent is used in combination with the fan element to reduce drag associated with turbulence behind the vehicle.

### DETAILED DESCRIPTION OF THE INVENTION

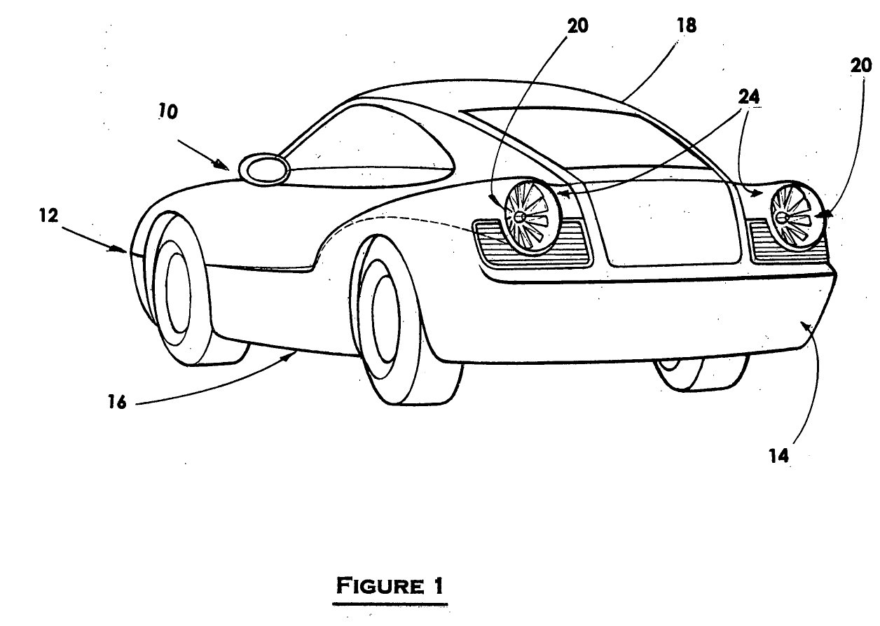

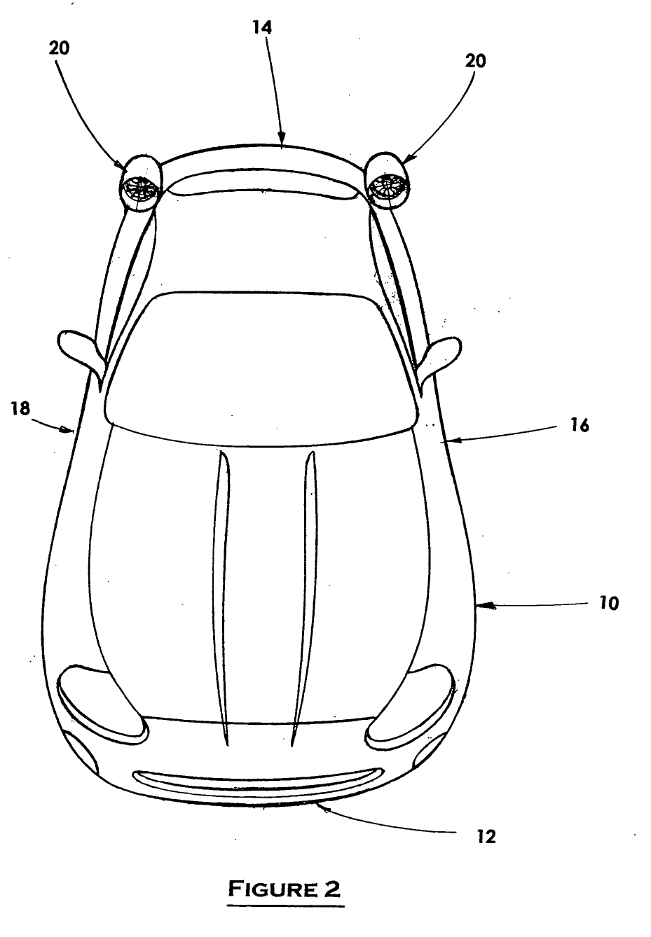

Referring to FIGS. 1 and 2, a vehicle 10 is shown having opposite front 12 and rear 14 ends. The vehicle 10 has opposite and spaced apart sides 16, 18 and is generally symmetrical about a longitudinally extending center line. Described in greater detail below, the vehicle 10 also includes at least one passive, undriven fan element driven by air flowing between the front 12 and rear 14 ends of the vehicle 10 for minimizing turbulence and drag behind the behind the vehicle 10 as the vehicle 10 moves in a forward direction.

In the illustrated embodiment, fan elements 20 are fixedly secured to the rear end 14 of the vehicle 10 by outwardly extending arms 24, 26. The fan elements 20 may be passive, wherein a flow of air passing over and around the vehicle 10 drives the fan elements 20 and is redirected to minimize turbulence and drag behind the rear end 14 of the vehicle 10.

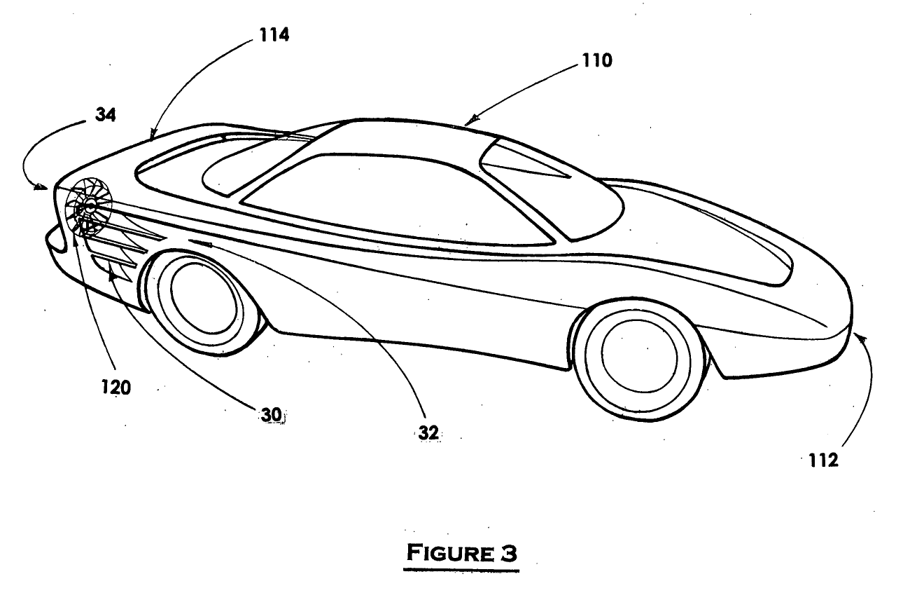

Referring to FIG. 3, a second embodiment is shown wherein the fan elements 120 are mounted behind a grill covering an inlet 30 formed in a rear quarter panel 32 so as to appear integral therewith. Air flow enters the inlet 30 and passes through the fan elements 120, thereby rotatably driving the fan elements 120. The air is expelled through an outlet 34 at the rear end 114 of the vehicle 110. The rotation of the fan elements 120 minimizes the low pressure area behind the rear end 114 that typically causes turbulences and drag.

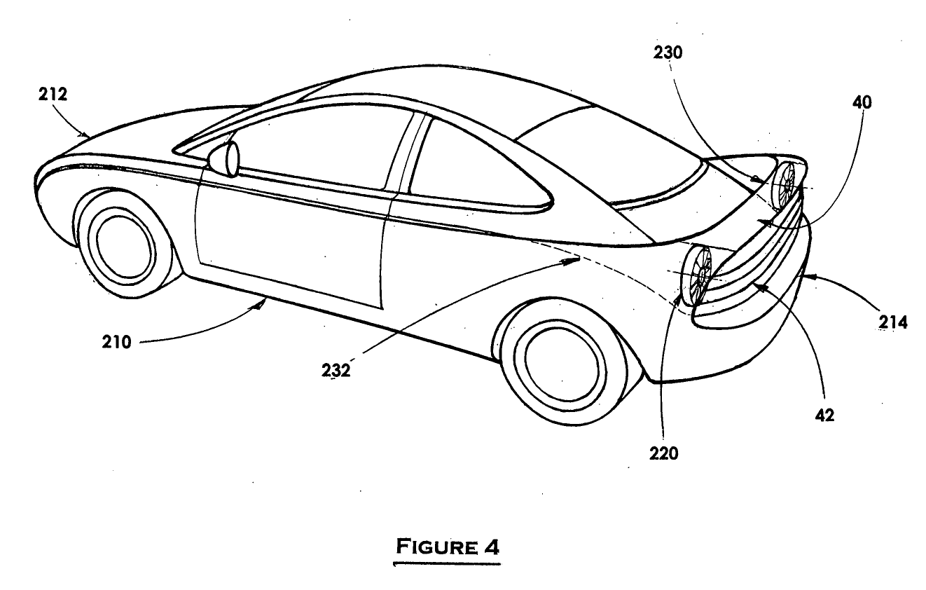

Referring to FIG. 4, a third embodiment is shown, wherein the fan elements 220 are mounted in the rear quarter panel 232 below a rear-mounted spoiler 40. In this design air flow is directed through an inlet 230 disposed beneath the spoiler and expelled through a grill-covered rear outlet 42. Similar to the embodiment shown in FIG. 3, the air flow is directed rearwardly behind the rear end 214 of the vehicle 210, so as to minimize or eliminate the low pressure area, which in turn minimizes turbulences. The rotation of the fan elements 220 minimizes the low pressure area behind the rear end 214 that typically causes turbulences and drag.

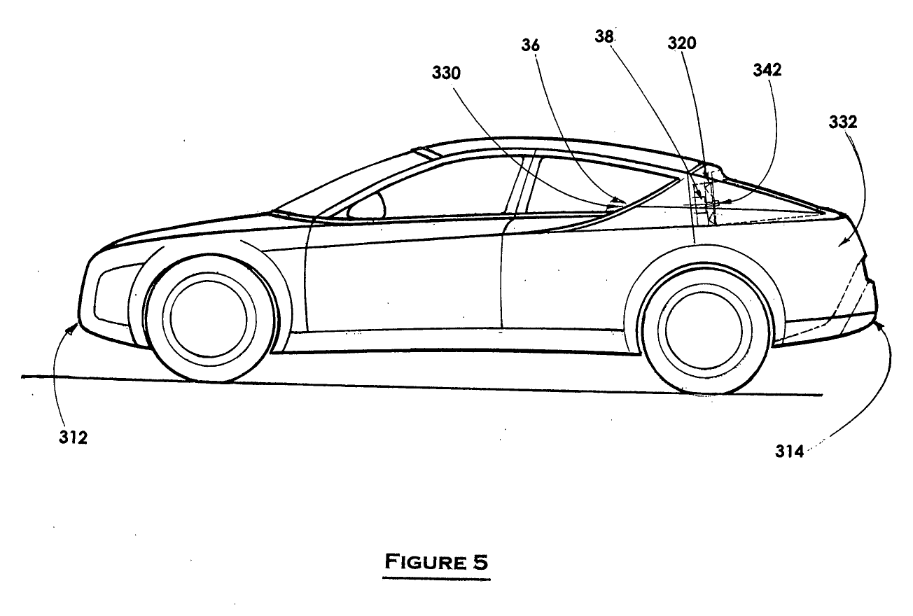

Referring to FIGS. 5, a fourth embodiment is shown, wherein the fan element 320 is disposed behind a scoop 36 that forms the inlet 330 for directing air flow toward the fan element 320. The fan element 320 is also coupled to a weighted flywheel 38 that rotates with the fan element 320. The flywheel 38 is accelerated by the rotation of the air-driven fan element 320 as the vehicle moves forward. Kinetic energy is stored by the continued rotation of the flywheel 38, which can be used to drive the fan element 320 when the air flow entering the inlet 330 is insufficient to drive the fan element 320, for example during a vehicle stop or low vehicle speeds. Preferably, the fan element 320 and flywheel 38 are rotatably coupled to the vehicle by friction-reducing bearings. The flywheel 38 may be directly coupled to the fan element 320 for rotation therewith about a common pivot axis. The flywheel 38 may also be coupled to the fan element 320 by a transmission or reducing gear set. The gear set may be selectively variable so that the inertia associated with the flywheel 38 is minimized to facilitate acceleration of the flywheel 38 in response to rotation of the fan element 320, i.e. one rotation of the fan element 320 causes multiple rotations of the flywheel 38. The gear set may also be selectively shifted when it is necessary to tap into the kinetic energy stored in the flywheel 38 to drive the fan element 320, so that one rotation of the flywheel 38 causes multiple rotations of the fan element 320. Actuation of the gear set between these modes may by controlled by a control system that monitors vehicle speed and wind conditions, so as to optimize operation of the flywheel 38 and fan element 320 and minimize turbulence and drag behind the forward moving vehicle.

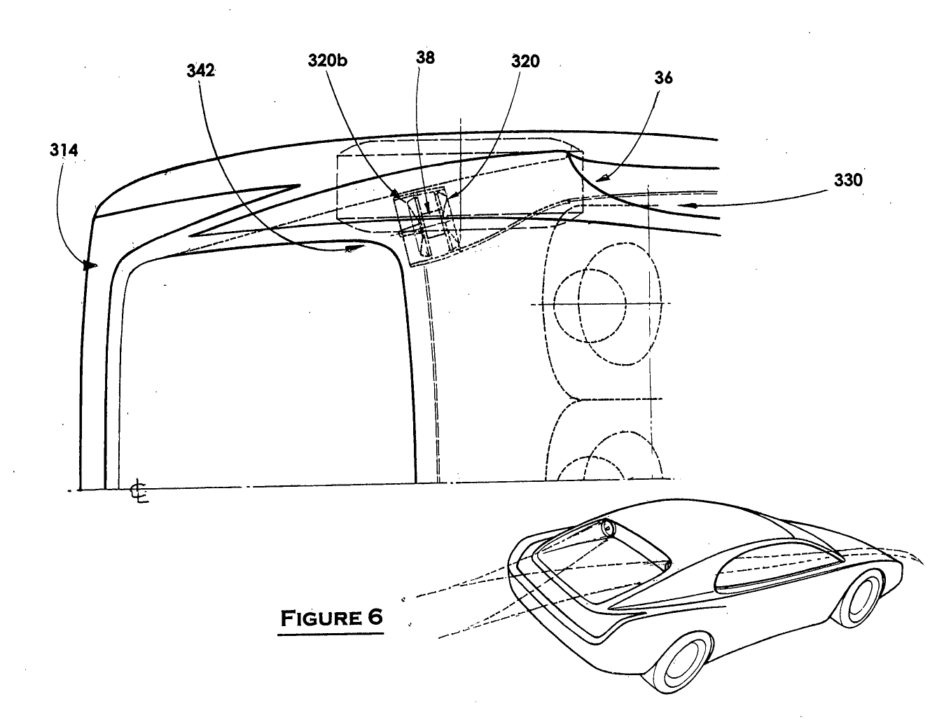

Referring to FIG. 6, a fifth embodiment is shown wherein multiple fan elements 320, 320b are utilized is series for controlling air flow behind the vehicle. Further, the rotational axes of the fans 320, 320b are angled or nonparallel with the longitudinal axis of the vehicle.

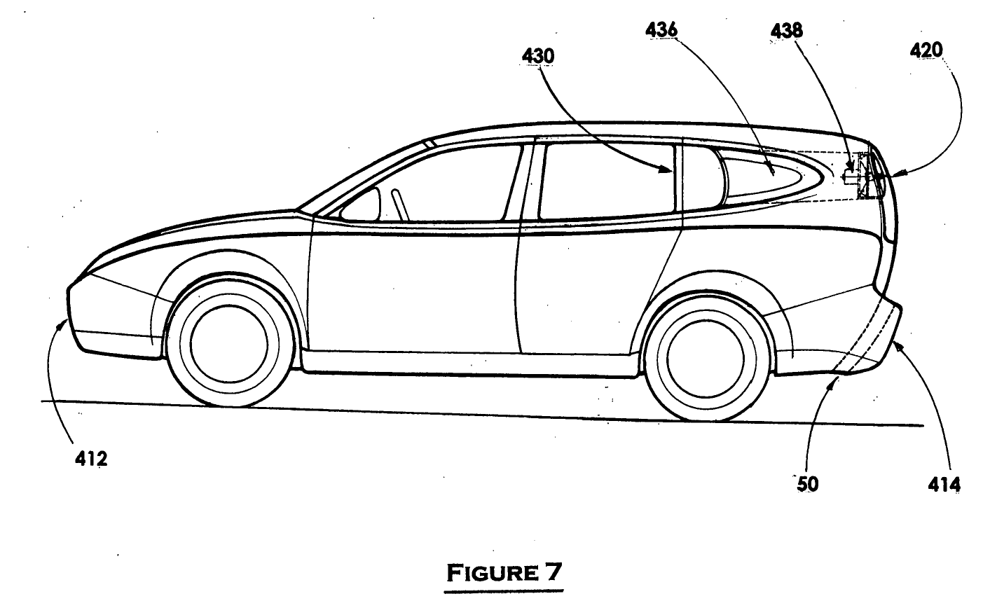

Referring to FIG. 7, a sixth embodiment is shown, in which a vent 50 is used for directing air moving beneath the vehicle toward an area immediately behind the vehicle. The vent 50 works with the fan element 420 to minimize turbulence behind the forward moving vehicle and, thereby reduce drag.

In all of the aforementioned embodiments, the fan elements are passively driven by air moving between the front and rear ends of the vehicle. Alternatively, the fan elements may be movably mounted to the rear end of the vehicle for either manual adjustment of the orientation of the fan elements or for automatic adjustment in response to predefined factors, such as vehicle speed or relative wind speed and/or direction. The fan elements may also be controlled automatically in response to predefined factors, such as vehicle speed or relative wind speed and/or direction.

The invention has been described in an illustrative manner. It is, therefore, to be understood that the terminology used is intended to be in the nature of words of description rather than of limitation. Many modifications and variations of the invention are possible in light of the above teachings. For example, one or more than two fan elements may be mounted to the vehicle and may be mounted in other areas conducive to minimizing drag due to turbulence toward and/or behind the rear end of the vehicle. The fan elements may also be induction type or standard propeller/impeller type fans. Additionally, any of the features described above in connection with any of the embodiments may be combined with features from any other of the embodiments described herein. Thus, it should be clear that within the scope of the appended claim, the invention may be practiced other than as specifically described.

I claim:

1. A vehicle comprising:
a front end; a rear end; and a fan element disposed between the front and rear end of the vehicle, the fan element pivotally coupled to the vehicle and controlling a flow of air toward and from the rear end of the vehicle to minimize turbulence and drag behind the vehicle as the vehicle moves forwardly.

2. The vehicle as set forth in claim 1, wherein the fan element is passive and driven by air flowing between the front and rear ends of the vehicle.

3. The vehicle as set forth in claim 2, wherein the fan element is driven only by air flowing over a top surface of the vehicle.

4. The vehicle as set forth in claim 3, wherein the fan element is drivingly coupled to a weighted flywheel that rotates in response to rotation of the fan element.

5. The vehicle as set forth in claim 4, wherein the flywheel is directly coupled to the fan element for rotation therewith about a common pivot axis.

6. The vehicle as set forth in claim 4, wherein the flywheel drivingly coupled to the fan element by a transmission.

7. The vehicle as set forth in claim 6, wherein the transmission operates in one mode in which one rotation of the fan element causes multiple rotations of the flywheel.

8. The vehicle as set forth in claim 7, wherein the transmission operates in a second mode, in which one rotation of the flywheel causes multiple rotations of the fan element.

9. The vehicle as set forth in claim 8, wherein the transmission operates in a third mode, in which flywheel and fan element rotate the same number of revolutions about respective pivot axes.

10. The vehicle as set forth in claim 9, wherein the fan element, flywheel and transmission are disposed behind a side-mounted scoop that forms an inlet for directing air flow toward the fan element.

11. The vehicle as set forth in claim 1, wherein the fan element is disposed behind a grill-covered inlet integral with a rear quarter panel of the vehicle.

12. The vehicle as set forth in claim 1, wherein the fan element is disposed below a spoiler mounted to the rear end of the vehicle.

13. The vehicle as set forth in claim 12, wherein an inlet for directing air flow toward the fan element is disposed below the spoiler.

14. The vehicle as set forth in claim 1, wherein the rotational axis of the fan is nonparallel with a longitudinal axis of the vehicle.

15. The vehicle as set forth in claim 14 including a pair of fan elements disposed on opposite sides of the vehicle in a generally symmetrically opposite manner, the fan elements being rotatable about rotational axes that extend rearwardly inwardly toward each other.

16. The vehicle as set forth in claim 1 including a plurality of fan elements rotatable about a common rotational axis.

17. The vehicle as set forth in claim 16, wherein the rotational axis of the fan elements is nonparallel with respect to a longitudinal axis of the vehicle.
